(19) United States
(12) Patent Application Publication
(10) Pub. No.: US 2025/0269474 A1
(43) Pub. Date: Aug. 28, 2025

(54) HEAT EXCHANGER BASED ON AN ALUMNIMIUM ALLOY OBTAINED BY BRAZING

(71) Applicant: CONSTELLIUM NEUF-BRISACH, Biesheim (FR)

(72) Inventors: Armelle DANIELOU, Les Echelles (FR); Diana KOSCHEL, La Buisse (FR); Laurent BOISSONNET, Voiron (FR)

(21) Appl. No.: 18/858,028

(22) PCT Filed: Apr. 18, 2023
(86) PCT No.: PCT/FR2023/050549

§ 371 Date: Oct. 18, 2024

(30) Foreign Application Priority Data
Apr. 19, 2022 (FR) FR2203601

(51) Int. Cl. B23K 35/02; B23K 35/28; C21D 8/02; C22C 21/02

(52) U.S. Cl. CPC B23K 35/0238; B23K 35/286; C21D 8/0226; C21D 8/0236; C21D 8/0273; C21D 8/0278; C22C 21/02

(57) ABSTRACT

The present invention relates to a strip or sheet, intended for manufacturing brazed heat exchangers, comprising a core layer 18, possibly a cover layer 16, 17 on one or two face(s) of the core layer 18 and possibly an interlayer on one or two face(s) of the core layer 18 placed between the core layer 18 and the cover layer 16, 17, the core layer 18 being made of the 6xxx series of aluminum alloy having the following composition, in weight percentages: Si: from 0.45 to 0.75%; Fe: from 0.18 to 0.40%; Cu: ≤0.40%; Mn: ≤0.30%; Mg: from 0.25 to 0.56%; Ti: <0.050%; optionally V: from 0.05 to 0.16%; unavoidable impurities: <0.05% each and <0.15% in total; the remainder being aluminum.

### TECHNICAL FIELD

The invention relates to thin strips or sheets (with a thickness generally comprised between 0.1 and 2.5 mm) made of an aluminum-magnesium-silicon core alloy (the 6xxx series according to the nomenclature of the Aluminum Association), possibly plated on one or two face(s) of a cover alloy, most often an aluminum-silicon brazing alloy (the 4xxx series according to the nomenclature of the Aluminum Association) or a sacrificial aluminum alloy, aluminum-manganese or aluminum-zinc (the 1xxx, 3xxx or 7xxx series according to the nomenclature of the Aluminum Association), and/or of an intermediate alloy, placed between the core layer and the possible brazing alloy, of aluminum or aluminum-manganese alloy (the 1xxx or 3xxx series according to the nomenclature of the Aluminum Association). In particular, these strips or sheets are intended for the manufacture of elements, such as plates of heat exchangers assembled by brazing, in particular for motor vehicles, such as coolers of batteries of electric vehicles. For example, the techniques of brazing aluminum alloys are described in the article by J. C. Kucza, A. Uhry and J. C. Goussain “Le brasage fort de l′aluminium et ses alliages”, published in Soudage et Techniques Connexes, November-December 1991, pp . . . 18-29. In particular, the strips or sheets according to the invention may be used in brazing techniques with a non-corrosive flux of the NOCOLOK® or CAB (“controlled atmosphere brazing”) type.

### PRIOR ART

With the development of electric vehicles, the battery cooler market is rapidly expansion. A current objective of this part is to control the operating temperature of the batteries within a range generally from 20 to 100° C., preferably from 30 to 80° C. The parts may be large sized (1 to 2 meters).

An example of a current design of an electric vehicle battery cooler is shown in FIG. 1. It is composed of two portions with a core layer 15 made of an alloy of the 3xxx series: a flat part 11 and a stamped part 12, assembled so as to create a channel 13. In the present description, the term “flat part” refers to a part that is not stamped before assembly. On the other hand, the term “stamped part” refers to a part that is stamped before assembly, so as to create a channel after assembly with a flat part. In operation, the channel is used for the circulation of the cooling fluid in the electric vehicle battery cooler. Besides the core layer 15 made of the 3xxx series alloy, a sacrificial layer 16, for example made of an alloy of the 7xxx or 1xxx series, may be added to guarantee the corrosion resistance SWAAT on the outer face of each of the two parts 11 and 12. The stamped part 12 also comprises a brazing layer 17 made of an alloy of the 4xxx series, on the other side of the core layer 15 made of the 3xxx series alloy with respect to the sacrificial layer 16, to ensure brazing of the two parts 11 and 12 together. The batteries 14 are in contact with the flat part 11, but not with the stamped part 12.

In particular, the properties required for the aluminum alloy strips or sheets used for the manufacture of brazed exchangers include a sufficient formability for easy shaping of the plates before brazing, a good brazability, a high mechanical strength after brazing, so as to use thicknesses as low as possible and to ensure part of the strength of the complete structure of the battery box, a good resistance to fatigue stress in operation, and a good resistance to corrosion after brazing. Of course, it is important for the selected alloy to be easy to cast and to roll, and that the manufacturing cost of the strips or sheets is compatible with the requirements of the automotive industry.

In order to promote the reduction in thickness of the plates for the heat exchangers (like the coolers of the batteries of electric vehicles, which may possibly also serve as structural parts), it is in particular interesting to increase the mechanical properties of the material after brazing, in particular the yield strength (Rp_{0.2}) of the tensile strength curve obtained according to the standard ISO 6892-1 (“Yield Strength” or “YS” in English), without reducing corrosion resistance or brazability.

In this respect, solutions have been proposed. Mention may be made, for example, of the following patents and patent applications, disclosing the compositions and configurations hereinafter:
JP2005/261026 discloses a core made of an alloy of the 3xxx series comprising in particular, in weight percentages: >0.8% Mn; 0.3-0.6% Mg; <0.5% Si, used in particular for tubes.
EP1254965 discloses a structural-hardening aluminum alloy having the following composition, in weight percentages: 0.6-0.9% Si; 0.1-0.36% Mg; 0.4-0.7% Mn; 0.1-0.25% Ti; 0.25-0.35% Cu; <0.7% Fe; optionally 0.05-0.25% Zr.
EP1687456 relates to the field of fluxless brazing and discloses a core comprising, in weight percentages: 0.3-1.0% Si; <1.0% Fe; 0.3-1.0% Cu; 0.3-2.0% Mn; 0.3-3.0% Mg; <6% Zn; <0.1% Ti; <0.3% Zr; <0.3% Cr; <2.0% Ni; <2.0% Co; <0.5% Bi; <0.5% Y; other elements <0.05% each and <0.15% in total, the remainder being aluminum, coated on at least one face with a brazing aluminum alloy comprising, in weight percentages: 4-15% Si and 0.01-0.5% of at least one of the elements Ag, Be, Bi, Ce, La, Pb, Pd, Sb, Y or mischmetal.
EP3423607 discloses a solution made of an alloy of the 6xxx series alloy solution comprising, in weight percentages: 0.2-1.3% Si; 0.40-1.3% Mg; ≤0.80% Cu; 0.05-1.0% Fe; 0.05-0.70% Mn; optionally one or two element(s) selected from among 0.05-0.35% Zr and 0.04-0.35% Cr; ≤25% Zn; ≤0.25% Ti; the remainder being unavoidable impurities and aluminum, or the Fe/Mn ratio is lower than 1.90.
WO2021204929 discloses a core made of an alloy of the AA6xxx series, having the following composition, in weight percentages: 0.5-0.9% Si; ≤0.5% Fe; ≤0.5% Cu; ≤0.5% Mn; 0.4-0.8% Mg; ≤0.3% Cr; ≤0.3% Zn; ≤0.3% Ti; ≤0.1% Zr; the remainder being aluminum and unavoidable impurities, 0.05% at most each and 0.15% at most in total.

Yet, the proposed solutions do not necessarily allow solving the good tradeoff between good mechanical strength after brazing, in particular in terms of Rp_{0.2}, a good corrosion resistance and a good brazability, in particular with a solidus temperature of the alloy of the core layer that is high enough to enable melting of the brazing layer while avoiding melting of the layer core. Considering an increasing market demand, there is still a need for a novel core alloy having an improved mechanical strength in comparison with existing alloys, in particular in terms of Rp_{0.2}, without degradation of corrosion resistance or of brazability. Such a core alloy could allow meeting the demand which is always present in terms of reducing the thickness of the products and the demand to develop solutions with high mechanical properties for battery coolers in order to improve their contribution to the overall strength of the structure protecting the batteries (which includes the heat cooler, but also the parts encapsulating the batteries, integrated or not integrated into the body of the vehicle).

### DISCLOSURE OF THE INVENTION

The Applicant has determined a composition range, surprisingly, allowing improving the mechanical strength without degradation of corrosion resistance or of brazability. For example, the target according to the present invention may be to reach a yield strength Rp_{0.2} higher than or equal to about 130 MPa, preferably 150 MPa, preferably 180 MPa, or higher than or equal to about 190 MPa, or higher than or equal to about 200 MPa, for the industrial strips or sheets after brazing.

In particular, the solution according to the present invention is based on at least one of the following elements, which could relate to the composition of the alloy of the core layer, the configuration of the flat and stamped parts or the manufacturing method:
Using a core layer made of an alloy of the 6xxx series, having a composition as described according to the present invention, preferably preserving a solidus temperature for example higher than 615° C., in particular in the case where the core is plated with a brazing layer comprising an aluminum alloy of the 4xxx series, whose solidus temperature is about 577° C., for example an AA4343 or AA4045 alloy. In general, the solidus temperature of the core layer made of an alloy of the 6xxx series is preferably at least 20° C., preferably at least 30° C., preferably at least 40° C., with respect to the solidus temperature of the brazing layer;
Using a sacrificial layer on both faces of this core layer made of an alloy of the 6xxx series for the flat part 11 of the heat exchanger, to ensure good corrosion resistance on the outer side of the heat exchanger, i.e. on the side of the flat part 11 opposite that one where the stamped part 12 is located.
Assembling a flat part 11, having an core layer 18 made of an alloy of the 6xxx series plated on both faces thereof with a sacrificial layer 16, and another part 12, having an core layer 18 made of an alloy of the 6xxx series plated on one face with a brazing layer 17 and on the other face with a sacrificial layer 16, which is stamped to form a channel 13, between the flat part 11 and the stamped part 12, as illustrated in FIG. 2. After assembly, according to the non-limiting configuration of FIG. 2, the brazing layer 17 of the stamped part 12 is located between the core layer 18 of an alloy of the 6xxx series of the stamped part 12 and one of the sacrificial layers 16 of the flat part 11. It should be noted that the two core layers 18 made of an alloy of the 6xxx series or the two sacrificial layers 16 may have the same composition or different compositions. It should also be noted that, according to one variant, there could be a sacrificial layer between the core layer 18 made of an alloy of the 6xxx series and the brazing layer 17.
Brazing, for example in a CAB furnace (brazing under a controlled atmosphere, for example with control of the amount of nitrogen or argon and/or oxygen) at a temperature preferably lower than 615° C., preferably lower than 610° C., preferably lower than 605° C. Above 570° C., limiting the amount of oxygen to less than 100 ppm, preferably less than 50 ppm, could allow improving the quality of the brazing.
Preferably ensuring cooling at the end of the brazing cycle, preferably at a rate higher than 25° C./min, preferably higher than 40° C./min, preferably higher than 50° C./min below 380° C. and up to 100° C. A rapid cooling could allow avoiding or reducing the formation of coarse-sized precipitates (Mg, Si), for example larger than 150 nm, which might reduce the hardening potential of the alloy, in particular Rp_{0.2}.
Optionally adding a post-brazing tempering step, preferably at a temperature of 180 to 220° C., preferably for a duration shorter than 6 hours, preferably shorter than 3 hours, preferably shorter than or equal to 2 hours (for example for 2 hours at 195° C. or for 30 minutes at 205° C.) Thus, an object of the invention is a strip or sheet, intended for the manufacture of brazed heat exchangers, preferably electric vehicle battery coolers, comprising, preferably consisting of, a core layer, possibly a cover layer on one or two face(s) of the core layer and possibly an interlayer on one or two face(s) of the core layer placed between the core layer and the cover layer, the core layer being made of an aluminum alloy of the 6xxx series having the following composition (% by weight):
Si: from 0.45 to 0.75; preferably from 0.50 to 0.70%; preferably from 0.55 to 0.65%;
Fe: from 0.10 to 0.40%; preferably from 0.12 to 0.35%; preferably from 0.14 to 0.30%; preferably from more than 0.18 to 0.26%;
Cu: ≤0.50%; preferably ≤0.45%; preferably ≤0.25%; preferably ≤0.15%; and preferably >0.05%, according to a first variant; or preferably from 0.25 to 0.45%; preferably from 0.29 to 0.40%, according to a second variant;
Mn: ≤0.30%; preferably ≤0.20%; preferably ≤0.15%; preferably ≤0.10%;
Mg: from 0.25 to 0.56%; preferably from 0.25 to 0.45%; preferably from 0.30 to 0.39%;
Ti: <0.050%; preferably <0.045%; preferably <0.040%;
optionally V: from 0.05 to 0.16%;
unavoidable impurities: <0.05% each and <0.15% in total;
the remainder being aluminum.

Another object of the invention is a set of two sheets or strips comprising, preferably consisting of:
a flat part formed from a strip or sheet according to the present invention;
a stamped part formed from a strip or sheet according to the present invention;
   the two parts being intended to be assembled by brazing and forming a channel thanks to the deformation of the stamped part, the outermost layer of the stamped part and/or of the flat part in contact with the other part being a brazing layer.

Another object of the invention is a method for manufacturing a strip or sheet according to the present invention, comprising the successive steps of:
casting a plate made of a core alloy;
optionally homogenizing the plate at a temperature of 450 to 580° C., preferably from 520 to 560° C. for 1 to 24 hours;
possibly plating with a cover aluminum alloy on one or two face(s) of the core layer and possibly an interlayer aluminum alloy on one or two face(s) of the core layer;
preheating at a temperature of 400 to 550° C., preferably from 450 to 530° C., preferably from 480 to 510° C., preferably with holding at the maximum temperature for less than 30 hours, preferably for less than 20 hours, preferably for less than 12 hours, more preferably for less than 3 hours;
hot-rolling the plate possibly homogenized and possibly plated at a temperature of 390 to 530° C., preferably from 470 to 530° C., to a thickness of 2 to 6 mm,
cold-rolling to the desired thickness, the thickness of the strip or sheet after cold-rolling being preferably from 0.15 to 3 mm, and
heat treatment in a passage furnace at a temperature of 250 to 560° C., preferably from 320 to 430° C., preferably from 320 to 360° C., with holding at the maximum temperature for less than 5 minutes, preferably less than 1 minute, preferably for less than 30 seconds and preferably more than 15 seconds, or in a batch furnace, i.e. a furnace operating discontinuously, at a temperature of 250 to 390° C., preferably 310 to 360° C., with holding at the maximum temperature preferably for less than 3 hours, preferably for less than 2 hours and preferably less than 1 hour, so as to obtain a small-grain recrystallization.

Another object of the invention is a heat exchanger made at least in part from a strip or sheet according to the present invention or from a set of two sheets or strips according to the present invention.

Another object of the invention is the use of a strip or sheet according to the present invention or of a set of two sheets or strips according to the present invention, for the manufacture of a heat exchanger, preferably a battery cooler of an electric vehicle.

### FIGURES

FIG. 1 is a cross-sectional diagram describing a current design of a battery cooler of an electric vehicle.

FIG. 2 is a cross-sectional diagram describing a design of a battery cooler of an electric vehicle according to the present invention.

FIG. 3 is a diagram describing mounting of the sheets for the brazability test of Example 1.

FIG. 4 is a diagram describing mounting and perforation analysis during the SWAAT corrosion resistance test of Example 3.

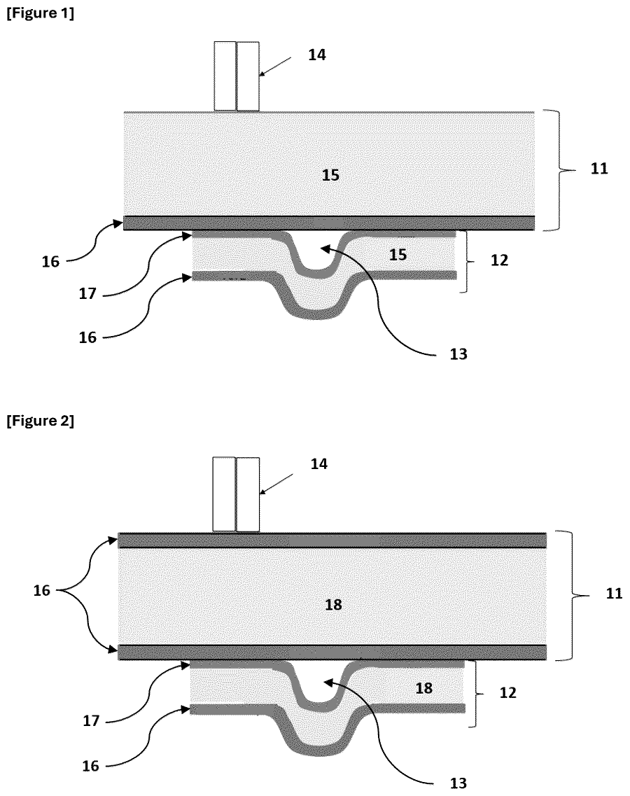

### DETAILED DESCRIPTION OF THE INVENTION

In the description and the claims, unless indicated otherwise:
the designation of the aluminum alloys is in compliance with the nomenclature of The Aluminum Association;
the contents of chemical elements are designated in weight percentages.

### Aluminum Alloy of the Core Layer

The composition limits of the 6xxx series aluminum alloy of the core layer used according to the present invention are expressed in weight percentages and may be justified as follows. Silicon: A minimum Si content of 0.45% allows improving the mechanical properties, in particular by formation of hardening precipitates containing magnesium and silicon during the post-brazing tempering. Hence, the silicon content is preferably higher than or equal to 0.45%, or higher than or equal to 0.46%, or higher than or equal to 0.47%, or higher than or equal to 0.48%, or higher than or equal to 0.49%, or higher than or equal to 0.50%, or higher than or equal to 0.51%, or higher than or equal to 0.52%, or higher than or equal to 0.53%, or higher than or equal to 0.54%, or higher than or equal to 0.55%.

An excessively high Si content could reduce the solidus temperature of the core and compromise brazing. It is then preferable to limit Si to a content lower than or equal to 0.75%, or lower than or equal to 0.74%, or lower than or equal to 0.73%, or lower than or equal to 0.72%, or lower than or equal to 0.71%, or lower than or equal to 0.70%, or lower than or equal to 0.69%, or lower than or equal to 0.68%, or lower than or equal to 0.67%, or lower than or equal to 0.66%, or lower than or equal to 0.65%.

Preferably, the Mg/Si weight ratio is comprised from 0.4 to 1.0, preferably from 0.5 to 0.9.

Iron: A maximum Fe content of 0.40%, or 0.39%, or 0.38%, or 0.37% or 0.36%, or 0.35%, or 0.34%, or 0.33%, or 0.32%, or 0.31%, or 0.30%, or 0.29%, or 0.28%, or 0.27%, or 0.26%, may also be favorable to corrosion resistance and formability, in particular by reducing the fraction of coarse precipitates containing Fe. However, it is not necessary to descend to very low contents, for example lower than 0.08%, which would lead to high cost prices. Consequently, the preferred minimum content of Fe is 0.10%, or 0.11%, or 0.12%, or 0.13%, or 0.14%, or 0.15%, or 0.16%, or 0.17%, or 0.18%.

Copper: Cu is a hardening element which contributes to mechanical strength. When an additional layer is present, a copper gradient is created during brazing and has the effect of reducing corrosion on the inner side of the exchanger, i.e. on the side of the channels where the fluid circulates. Yet, beyond a given content, the risk of forming cracks during casting is higher, and sensitivity to corrosion in the core could be increased. Coarse intermetallic compounds could also form during casting which alter the homogeneity of the metal and could constitute initiation sites for corrosion. Cu is also an element that reduces the solidus temperature. Hence, the Cu content is lower than or equal to 0.50%, or lower than or equal to 0.49%, or lower than or equal to 0.48%, or lower than or equal to 0.47%, or lower than or equal to 0.46%, lower than or equal to 0.45%, or lower than or equal to 0.40%, or lower than or equal to 0.35%, or lower than or equal to 0.30%, or lower than or equal to 0.25%, or lower than or equal to 0.20%, or lower than or equal to 0.15%. Preferably, the Cu content is higher than 0.05%, or higher than or equal to 0.20%, or higher than or equal to 0.21%, or higher than or equal to 0.22%, or higher than or equal to 0.23%, or higher than or equal to 0.24%, or higher than or equal to 0, 25%, or higher than or equal to 0.26%, or higher than or equal to 0.27%, or higher than or equal to 0.28%, or higher than or equal to 0.29%.

Manganese: The addition of Mn could allow increasing the solidus. To do so, the Mn content is preferably higher than or equal to 0.01%, or higher than or equal to 0.02%, or higher than or equal to 0.025%, or higher than or equal to 0.03%, or higher than or equal to 0.04%, or higher than or equal to 0.05%, or higher than or equal to 0.06%, or higher than or equal to 0.07%, or higher than or equal to 0.08%, or higher than or equal to 0.09%, or higher than or equal to 0.10%. To avoid forming a large number of coarse phases during casting, which could reduce formability, and dispersoids, which could deteriorate the hardenability during cooling of the brazing, serving as germination sites for precipitates containing Mg, it is recommended to limit Mn to a content lower than or equal to 0.30%, or lower than or equal to 0.29%, or lower than or equal to 0.28%, or lower than or equal to 0.27%, or lower than or equal to 0.26%, or lower than or equal to 0.25%, or lower than or equal to 0.24%, or lower than or equal to 0.23%, or lower than or equal to 0.22%, or lower than or equal to 0.21%, or lower than or equal to 0.20%, or lower than or equal to 0.19%, or lower than or equal to 0.18%, or lower than or equal to 0.17%, or lower than or equal to 0.16%, or lower than or equal to 0.15%, or lower than or equal to 0.14%, or lower than or equal to 0.13%, or lower than or equal to 0.12%, or lower than or equal to 0.11%, or lower than or equal to 0.10%. To maximize the mechanical properties, in particular Rp_{0.2}, it is preferred to limit the Mn content to a content lower than or equal to 0.10%.

Magnesium: The Mg content according to the present invention is controlled in order to enable brazing two parts together (the flat part and the stamped part), each having a core made of an aluminum of the 6xxx series. This would be different if one of the two cores were made of an aluminum alloy of the 3xxx series. Mg is an element which, in combination with silicon, allows creating a structural hardening during the post-brazing tempering. Also, the minimum Mg content according to the present invention is preferably higher than or equal to 0.25%, or higher than or equal to 0.26%, or higher than or equal to 0.27%, or higher than or equal to 0.28%, or higher than or equal to 0.29%, or higher than or equal to 0.30%, or higher than or equal to 0.31%, or higher than or equal to 0.32%, or higher than or equal to 0.33%. Furthermore, the maximum Mg content according to the present invention is preferably lower than or equal to 0.56%, or lower than or equal to 0.55%, or lower than or equal to 0.54%, or lower than or equal to 0.53%, or lower than or equal to 0.52%, or lower than or equal to 0.51%, or lower than or equal to 0.50% or lower than or equal to 0.49%, or lower than or equal to 0.48%, or lower than or equal to 0.47%, or lower than or equal to 0.46%, or lower than or equal to 0.45%, or lower than or equal to 0.44%, or lower than or equal to 0.43%, or lower than or equal to 0.42%, or lower than or equal to 0.41%, or lower than or equal to 0.40% or lower than or equal to 0.39%.

Titanium: Ti may allow controlling the size of the grains during casting. Preferably, its content according to the present invention is lower than 0.050%, or lower than 0.049%, or lower than 0.048%, or lower than 0.047%, or lower than 0.046%, or lower than 0.045%, or lower than 0.044%, or lower than 0.043%, or lower than 0.042%, or lower than 0.041%, or lower than 0.040%.

Vanadium: vanadium may optionally be added to ensure a complementary hardening and increase the solidus temperature of the alloy. If its content exceeds 0.16%, primaries could form during casting. Preferably, its content according to the present invention is lower than 0.16%, or lower than 0.15%, or lower than 0.14%, or lower than 0.13%, or lower than 0.12%, or lower than 0.11%, or lower than 0.10%. Preferably, the minimum content of Vis 0.05% when the latter is added.

Preferably, the solidus temperature of the 6xxx series aluminum of the core layer is higher than 595° C., preferably higher than 600° C., preferably higher than 605° C., preferably higher than 610° C., preferably higher than 615° C. Preferably, the solidus temperature of the core layer made of the 6xxx series alloy is at least 20° C., preferably at least 30° C., preferably at least 40° C., with respect to the solidus temperature of the brazing layer. The solidus temperature of the 6xxx series aluminum of the core layer should be adapted according to the brazing conditions in a manner known to a person skilled in the art.

It should be noted that the 6xxx series aluminum alloy of the core layer of the flat and stamped parts may be the same alloy or two different alloys. Preferably, it is the same alloy.

### Aluminum Alloy of the Cover Layer

According to the present invention, the cover layer may be a sacrificial layer or a brazing layer.

### Sacrificial Layer:

According to a variant of the present invention, the strip or sheet comprises a cover layer which is a sacrificial layer 16 over at least one face of the core layer 18. Preferably, the aluminum alloy of the sacrificial layer 16 comprises less than 2.50%, and preferably at least 0.50% by weight Zn.

According to a variant of the present invention, the aluminum alloy of the sacrificial layer is selected from among an aluminum alloy of the 1xxx, 7xxx or 3xxx series, preferably of the 7xxx or 3xxx series.

According to one variant, the aluminum alloy of the sacrificial layer may be an aluminum alloy of the 7xxx series, preferably having the following composition, in weight percentages: less than 0.50% Si; less than 0.50% Fe; less than 0.25% Cu; less than 0.30% Mn; less than 0.20%, preferably less than 0.15% Mg; from 0.70 to 5.00%, preferably from 0.70 to less than 4.50%, according to one variant from 0.50 to less than 2.50%, preferably from 0.70 to less than 2.50%, preferably from more than 0.80 to less than 1.30% Zn; less than 0.15% Ti; other elements less than 0.05% each and less than 0.15% in total; the remainder being aluminum.

For example, the AA7072 composition is an aluminum alloy which could be suitable as a sacrificial layer according to the present invention. Its composition is, in weight percentages: less than 0.05% Si; less than 0.05% Fe; less than 0.10% Cu; less than 0.10% Mn; less than 0.10% Mg; from 0.80 to 1.30% Zn; other elements less than 0.05% each and less than 0.15% in total; the remainder being aluminum.

According to another variant, the aluminum alloy of the sacrificial layer may be an aluminum alloy of the 3xxx series, preferably having the following composition, in weight percentages: from 0.10 to 0.35% Si; less than 0.70% Fe; less than 0.20% Cu; from 0.70 to 2.00%, preferably from 0.90 to 1.30% Mn; from 0.70 to 5.00%, preferably from 0.70 to less than 4.50%, preferably from 0.70 to less than 2.50%, preferably from more than 0.80 to less than 1.30% Zn; less than 0.15% Ti; other elements less than 0.05% each and less than 0.15% total; the remainder being aluminum.

Preferred values of each of the elements of the alloys of the 3xxx series or of the 7xxx series, which could be suitable as a sacrificial anode according to the present invention, are given as example in Table 1 hereinafter (columns 3xxx-1, 7xxx-1 and 7xxx-2), in weight percentages.

TABLE 1

| | 3xxx-1 | 7xxx-1 | 7xxx-2 |
|---|---|---|---|
| Si | 0.10-0.35% | 0.05-0.30% | 0.15-0.40% |
| Fe | <0.70% | 0.25-0.45% | <0.40% |
| Cu | <0.20% | <0.15% | <0.15% |
| Mn | 0.7-1.30% | <0.15% | <0.10% |
| Mg | <0.05% | <0.05% | <0.10% |
| Cr | <0.05% | <0.05% | <0.05% |
| Ni | <0.05% | <0.05% | <0.05% |
| Zn | 0.9-1.55% | 0.80-1.30% | 3.50-4.50% |
| | | Pref. 0.80 to <1% | |
| Ti | <0.10 | <0.10% | <0.10% |
| | Pref. <0.05% | Pref. <0.05% | Pref. <0.05% |
| Zr | <0.05% | <0.05% | <0.05% |

### Brazing Layer:

Preferably, the aluminum alloy of the brazing layer is an aluminum alloy of the 4xxx series with a liquidus temperature low enough compared to the solidus of the core alloy to have enough temperature range for brazing, an acceptable mechanical strength and a good wettability. These alloys may contain addition elements, for example strontium, preferably in a weight content lower than 0.05%.

According to one variant, the brazing alloy of the present invention comprises Y, Sn and/or Bi. In particular, this variant is advantageous for fluxless brazing. Preferably, the brazing alloy comprises:
from 0.01 to 0.10%, preferably from 0.015 to 0.08%, preferably from 0.02 to 0.065% Y;
from 0.01 to 0.10%, preferably from 0.015 to 0.08%, preferably from 0.02 to 0.065% Sn; and/or
at most 0.04%, preferably at most 0.03%, preferably at most 0.02% Bi, according to a first variant; or at most 0.15%, preferably at most 0.12%, preferably less than 0.10%, and preferably at least 0.05%, preferably more than 0.06% Bi, according to a second variant.

Preferably, the aluminum alloy of the brazing layer does not comprise Bi.

Preferably, the aluminum alloy of the brazing layer is an alloy of the 4xxx series comprising from 4.00 to 13.00% by weight Si and less than 1.00% by weight Fe.

Preferably, the aluminum alloy of the brazing layer of the 4xxx series comprises (% by weight):
Si: from 5.00 to 13.00%, preferably from 6.00 to 11.00%;
Fe: less than 0.60%, preferably less than 0.50%, preferably less than 0.30%;
Cu: less than 0.40%, preferably less than 0.10%, preferably less than 0.05%;
Mn: less than 0.20%, preferably less than 0.10%, preferably less than 0.05%;
Mg: according to a first variant, less than 0.20%, preferably less than 0.10%, preferably less than 0.05%; or according to a second variant, from 0.50 to 2.50%, preferably from 1.00 to 2.00%;
Zn: less than 0.20%, preferably less than 0.10%, preferably less than 0.05%, preferably less than 0.02%;
Ti: less than 0.30%, preferably less than 0.10%, preferably less than 0.05%;
possibly Bi, Y, Sr and/or Sn;
other elements: less than 0.05% each and less than 0.15% in total;
the remainder being aluminum.

For example, the AA4045 composition is an aluminum alloy which could be suitable as an alloy of the brazing layer according to the present invention. Its composition is, in weight percentages: from 9.0 to 11.0% Si, less than 0.80% Fe, less than 0.30% Cu, less than 0.05% Mn, less than 0.05% Mg, less than 0.10% Zn, less than 0.20% Ti, other elements less than 0, 05% each and less than 0.15% in total, the remainder being aluminum.

For example, the previous composition preferably comprises less than 0.60% Fe.

For example, the previous composition preferably comprises less than 0.10% Cu.

For example, the AA4343 composition is an aluminum alloy which could be suitable as a brazing alloy according to the present invention. Its composition is, in weight percentages: from 6.80 to 8.20% Si, less than 0.80% Fe, less than 0.25% Cu, less than 0.10% Mn, less than 0.05% Mg, other elements less than 0.05% each and less than 0.15% in total, the remainder being aluminum.

For example, the previous composition preferably comprises less than 0.30% Fe.

For example, the previous composition preferably comprises less than 0.10% Cu.

For example, the AA4004 composition is an aluminum alloy which could be suitable as a brazing alloy according to the present invention. Its composition is, in weight percentages: from 9.00 to 10.50% Si, less than 0.80% Fe, less than 0.25% Cu, less than 0.10% Mn, from 1.00 to 2.00% Mg, less than 0.20% Zn, other elements less than 0.05% each and less than 0.15% in total, the remainder being aluminum.

For example, the AA4104 composition is an aluminum alloy which could be suitable as a brazing alloy according to the present invention. Its composition is, in weight percentages: from 9.00 to 10.50% Si, less than 0.80% Fe, less than 0.25% Cu, less than 0.10% Mn, from 1.00 to 2.00% Mg, less than 0.20% Zn, from 0.02 to 0.20% Bi, other elements less than 0.05% each and less than 0.15% in total, the remainder being aluminum.

### Aluminum Alloy of the Interlayer

According to one embodiment, the strip or sheet according to the present invention is plated, on one or two face(s) of the core layer, with a so-called interlayer aluminum alloy, preferably of the 1xxx or 3xxx series, placed between the core layer and a cover layer, preferably a brazing layer, preferably comprising (in % by weight):
Si: less than 0.50%, more preferably less than 0.20%;
Fe: less than 0.70%, more preferably less than 0.30%, even more preferably less than 0.20%;
Mn: from 0.30 to 1.40%, more preferably from 0.50 to 0.90%, more preferably from 0.60 to 0.80%, or, according to one variant, from 1.00 to 1.30%;
Cu: less than 0.30%, preferably less than 0.10%, even more preferably less than 0.05%;
possibly Mg, Zn and/or In;
other elements <0.05% each and <0.15% in total;
the remainder being aluminum.

Preferably, the interlayer aluminum alloy of the strip or sheet according to the present invention comprises (% by weight): Si<0.15%; Fe<0.20%; Cu<0.10%; Mn from 0.60 to 0.80%; Mg<0.02% according to a first variant or Mg<0.50%, preferably <0.25% according to a second variant; other elements <0.05% each and <0.15% in total, the remainder being aluminum.

Preferably, the interlayer aluminum alloy is an AA3xxx series alloy.

According to one variant, the interlayer aluminum alloy may further comprise:
Zn according to a content of 1.5 to 2.3%; and/or
In according to a content of 0.005 to 0.04%.

According to one variant, the strip or sheet according to the present invention comprises an interlayer between the core and the cover layer only in the case where the cover layer is a brazing layer.

According to one variant, the strip or sheet according to the present invention does not comprise an interlayer.

### Strip or Sheet and Set of Two Strips or Sheets

### Strip or Sheet:

The strip or sheet according to the present invention is a so-called brazing strip or sheet, which may be used for the manufacture of different portions of a heat exchanger, for example tubes, plates, manifolds, battery cooling systems for electric vehicles, etc.

The strip or sheet according to the present invention may have a configuration with several layers, and in particular with 2, 3, 4 or 5 layers.

The two-layer configuration comprises a core layer plated on one single face with a cover layer, in particular either with a brazing layer, or with a sacrificial layer.

The three-layer configuration may comprise:
either a core layer plated on both faces thereof with a brazing layer;
either a core layer plated on both faces thereof with a sacrificial layer;
either a core layer plated on one single face with an interlayer, itself plated with a brazing layer or a sacrificial layer, preferably a brazing layer;
either a core layer plated on a first face with a brazing layer and on the other face with a sacrificial layer.

The four-layer configuration may comprise:
either a core layer plated on a first face with an interlayer, itself plated with a brazing layer or a sacrificial layer, preferably a brazing layer, and on the other face with a brazing layer;
either a core layer plated on a first face with an interlayer, itself plated with a brazing layer or a sacrificial layer, preferably a brazing layer, and on the other face with a sacrificial layer.

The five-layer configuration comprises a core layer plated on both faces thereof with an interlayer itself plated with a brazing layer or a sacrificial layer, preferably a brazing layer.

In each of the aforementioned configurations, when two brazing layers, two interlayers or two sacrificial layers are provided, then they may be identical or different in terms of composition.

Preferably, the layers are identical in terms of composition.

The preferred configurations are three-layer configurations, comprising:
either a core layer plated on two faces with a sacrificial layer;
or a core layer plated on one face with a sacrificial layer and over the other face with a brazing layer.

According to one variant, at least one interlayer may be present between the core layer and the sacrificial layer or the brazing layer. Yet, preferably, there is no interlayer in the strip or sheet according to the invention.

Preferably, the strip or sheet according to the present invention consists of a core layer made of the 6xxx series of aluminum alloy, a cover layer over one or both faces of the core layer and possibly an interlayer on one or two face(s) of the core layer placed between the core layer and the cover layer.

According to a first variant, the strip or sheet according to the present invention comprises a cover layer over one single face of the core layer, and:
the cover layer is a brazing layer; or
the cover layer is a sacrificial layer.

According to a second variant, the strip or sheet according to the present invention comprises a cover layer over the two faces of the core layer, and:
one of the cover layers is a sacrificial layer and the other cover layer is a brazing layer; or
the two cover layers are sacrificial layers; or
the two cover layers are brazing layers.

As regards the total thickness of the strip or sheet according to the present invention, it is preferably from 0.40 to 2.50 mm.

The thicknesses discussed herein correspond to the thicknesses before brazing. As regards the thicknesses of each layer, it should be noted that these are target values, for which an error margin of about 2% is commonly accepted in the field of plated sheets or strips for heat exchangers.

According to a first variant where the strip or sheet according to the present invention is intended for the manufacture of a flat part, the minimum total thickness of the strip or sheet is 1.05 mm, or 1.15 mm, or 1.25 mm, or 1.35 mm, or 1.45 mm, or 1.55 mm, or 1.65 mm or 1.75 mm, or 1.85 mm or 1.95 mm. According to this first variant, the maximum total thickness of the strip or sheet is preferably 2.50 mm, or 2.40 mm, or 2.30 mm, or 2.20 mm, or 2.10 mm.

According to a second variant where the strip or sheet according to the present invention is intended for the manufacture of a stamped part, the minimum total thickness of the strip or sheet is 0.50 mm, or 0.60 mm, or 0.70 mm, or 0.80 mm, or 0.90 mm. According to this second variant, the maximum total thickness of the strip or sheet is preferably 2.50 mm, or 2.30 mm, or 2.10 mm, or 1.90 mm, or 1.70 mm, or 1.50 mm or 1.30 mm or 1.10 mm.

As regards the thickness of the interlayer or of the sacrificial layer, it preferably represents from 4 to 15% of the total thickness of the strip or sheet according to the present invention. Preferably, the minimum thickness of the interlayer or of the sacrificial layer represents 5%, or 6% or 7% or 8% or 9% of the total thickness of the strip or sheet according to the present invention. Preferably, the maximum thickness of the interlayer or of the sacrificial layer represents 14%, or 13% or 12% or 11% of the total thickness of the strip or sheet according to the present invention.

As regards the thickness of the brazing layer, it preferably represents from 3 to 15% of the total thickness of the strip or sheet according to the present invention. Preferably, the minimum thickness of the brazing layer preferably represents 4% of the total thickness of the strip or sheet according to the present invention. Preferably, the maximum thickness of the brazing layer represents 14%, or 13% or 12% or 11% or 10% or 9% or 8% or 7% or 6% of the total thickness of the strip or sheet according to the present invention.

### Set of Two Sheets or Strips:

The sheets or strips according to the present invention may be combined together, possibly after shaping, to form a heat exchanger with channels. The set of two sheets or strips according to the present invention may be that one after assembly but before brazing or that one after brazing. Brazing does not modify the configuration, i.e. the order of the different layers and the respective position of the flat part with respect to the stamped part.

According to the present invention, the set of two sheets or strips comprises, preferably consists of:
a flat part formed from a strip or sheet according to the present invention;
a stamped part formed from a strip or sheet according to the present invention;
   the two parts being intended to be assembled by brazing and forming a channel thanks to the deformation of the stamped part, the outermost layer of the stamped part and/or of the flat part in contact with the other part being a brazing layer.
   The set of two sheets or strips according to the present invention may be in different variants.

According to a preferred first variant:
one of the parts, flat or stamped, consists of a core according to the present invention, plated on both faces thereof with a sacrificial layer, and
the other part, stamped or flat, consists of a core according to the present invention, plated on one face with an optional interlayer and a brazing layer, and on the other face with a sacrificial layer.

According to a second preferred variant, the two parts, flat and stamped, consist of a core according to the present invention, plated on one face with an optional interlayer and a brazing layer, and on the other face with a sacrificial layer.

In each of the variants described above, the brazing layer of at least one of the parts is located between the flat part and the stamped part.

### Method

Another object of the invention is a method for manufacturing a strip or sheet according to the present invention, comprising the successive steps of:
casting a plate made of a core alloy;
optionally homogenizing the plate at a temperature of 450 to 580° C., preferably from 520 to 560° C. for 1 to 24 hours;
possibly plating with a cover aluminum alloy on one or two face(s) of the core layer and possibly an intermediate aluminum alloy on one or two face(s) of the core layer;
preheating at a temperature of 400 to 550° C., preferably from 450 to 530° C., preferably from 480 to 510° C., preferably with holding at the maximum temperature for less than 30 hours, preferably for less than 20 hours, preferably for less than 12 hours, more preferably for less than 3 hours;
hot-rolling the plate possibly homogenized and possibly plated at a temperature of 390 to 530° C., preferably from 470 to 530° C., to a thickness of 2 to 6 mm,
cold-rolling to the desired thickness, the thickness of the strip or sheet after cold-rolling being preferably from 0.15 to 3 mm, and
heat treatment in a passage furnace at a temperature of 250 to 560° C., preferably from 320 to 430° C., preferably from 320 to 360° C. with holding at the maximum temperature for less than 5 minutes, preferably less than 1 minute, preferably for less than 30 seconds and preferably more than 15 seconds, or in a batch furnace at a temperature of 250 to 390° C., preferably from 310 to 360° C., with holding at the maximum temperature preferably for less than 3 hours, preferably for less than 2 hours and preferably less than 1 hours, so as to obtain a small-grain recrystallization.

In particular, said cover alloy of the method according to the present invention may be a brazing alloy, or a sacrificial layer, or two brazing alloys, or two sacrificial layers, or a brazing alloy and a sacrificial layer.

Preferably, there is no intermediate annealing during the rolling steps in the methods according to the present invention.

Before installing any plating materials, it is possible to proceed with a homogenization of the alloy plate of the core layer at a temperature comprised from 450 to 580° C., preferably from 520 to 560° C., preferably for 1 to 24 hours.

### Use

Another object of the invention is a heat exchanger made at least in part from a strip or sheet according to the present invention or from a set of two sheets or strips according to the present invention.

Another object of the invention is the use of a strip or sheet according to the present invention or of a set of two sheets or strips according to the present invention, for the manufacture of a heat exchanger, preferably a battery cooler of an electric vehicle.

The strips or sheets according to the present invention may be used in the manufacture of brazed heat exchangers, in particular of motor vehicles, such as engine cooling radiators, evaporators, heating radiators and charge air coolers, manifolds, battery coolers of electric vehicles, as well as in air-conditioning systems.

In particular, the manufacture of a heat exchanger according to the present invention may comprise at least one of the steps hereinafter:
Brazing in a CAB furnace (controlled atmosphere), preferably at a temperature of 590 to 615° C., preferably from 590 to 610° C., preferably from 590 to 605° C., preferably from 590 to 600° C.;
Ensuring a cooling preferably having a rate higher than 25° C./min, preferably higher than 35° C./min, preferably higher than 50° C./min below 380° C. and up to 100° C. at the end of the brazing cycle;
Carrying out a post-brazing tempering step at a temperature of 150 to 240° C., preferably from 180 to 220° C., for a duration preferably shorter than 6 hours, preferably shorter than 3 hours, preferably shorter than or equal to 2 hours (for example for 2 hours at about 195° C. or for 30 minutes at 205° C.). Preferably, the minimum temperature of the post-brazing tempering is higher than 180° C., or higher than or equal to 181° C., or higher than or equal to 182° C., or higher than or equal to 183° C., or higher than or equal to 184° C., or higher than or equal to 185° C., or higher than or equal to 186° C., or higher than or equal to 187° C., or higher than or equal to 188° C., or higher than or equal to 189° C., or higher than or equal to 190° C. An increase in the temperature of the post-brazing tempering could allow reducing the duration of this tempering.

For example, for a post-brazing tempering temperature higher than or equal to 185° C., the duration may be shorter than 4 hours.

### EXAMPLES

### Example 1: Brazability

Different aluminum alloy ingots of core layers, brazing layers and sacrificial layers have been cast in vertical semi-continuous casting (DC casting) with aluminum alloys having the compositions given in Table 2 hereinafter, in weight percentages:

TABLE 2

| | | | | | | | | Sr | T° |
|---|---|---|---|---|---|---|---|---|---|
| | Si | Fe | Cu | Mn | Mg | Zn | TI | (ppm) | solidus |
| Brazing | 9.71 | 0.20 | 0.006 | 0.02 | <0.014 | | 0.02 | 111 | 576 |
| layer-1 | | | | | | | | | |
| Sacrificial | 0.16 | 0.35 | 0.001 | 0.002 | 0.003 | 1.03 | 0.03 | | 642 |
| layer | | | | | | | | | |
| Core layer-1 | 0.57 | 0.24 | 0.09 | 0.13 | 0.55 | | 0.02 | <0.01 | 613 |
| Core layer-2 | 0.63 | 0.24 | 0.09 | 0.17 | 0.33 | | 0.03 | <0.01 | 617 |

Before assembling the different layers together:
the core layer aluminum alloy ingots have been homogenized (temperature higher than 530° C. for more than 2 hours and less than 24 hours) and hot-rolled, at a temperature of 380 to 500° C., to a thickness of about 30 mm;
the brazing layer alloy ingots have been scalped and then hot-rolled at a temperature of about 480-500° C. to a thickness of 1.8 mm;
the sacrificial layer alloy ingot has been hot-rolled, at a temperature of about 480-500° C., to a thickness of about 3.5 mm.

After brushing the faces in contact, sandwiches with a thickness of 35.3 mm have been made, having the following configuration: brazing layer/core layer/sacrificial layer. The brazing layer represented about 5% of the total thickness of the sandwich and the sacrificial layer represented about 10% of the total thickness of the sandwich.

The following two sandwiches have been made:
Config-1: brazing layer-1/core layer-1/sacrificial layer;
Config-2: brazing layer-1/core layer-2/sacrificial layer.

Afterwards, the sandwiches have been preheated to a temperature of about 490° C. for less than 5 hours, and then hot-rolled to a thickness of about 1.5 mm or about 0.8 mm.

Annealing for 2 hours at about 360° C. has been carried out.

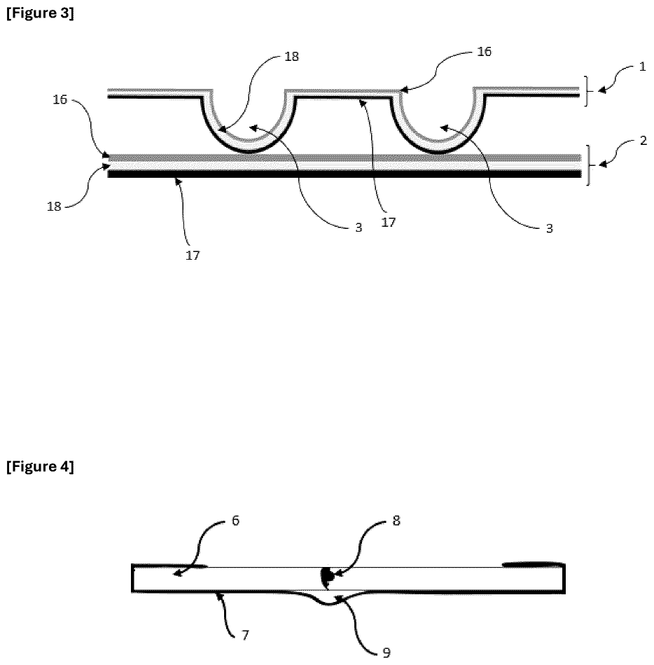

The sandwiches with a thickness of about 0.8 mm have been stamped, to create two lines and to obtain stamped sheets, as illustrated in FIG. 3. The sandwiches with a thickness of about 1.5 mm have not been stamped, to obtain non-stamped or flat sheets.

Afterwards, the brazability of the different sandwiches has been assessed. The brazing test has been carried out according to the following protocol, which allows simulating the assembly brazing between a stamped sheet and a non-stamped sheet. To do so, 50 mm×60 mm sheets have been stamped in the absence of lubricant to add two longitudinal stamped lines 3 as illustrated in FIG. 3. Afterwards, the stamped and non-stamped sheets have been degreased with an acetone solution and then dried with air. Afterwards, a stamped sheet and a non-stamped sheet having the same configuration and composition have been assembled as illustrated in FIG. 3. In FIG. 3, the reference 1 corresponds to a stamped sheet, the reference 2 corresponds to a non-stamped sheet, the reference 3 corresponds to two stamped lines, the reference 16 corresponds to a sacrificial layer, the reference 17 corresponds to a brazing layer made of the 4xxx series of aluminum alloy and the reference 18 corresponds to a core made of the 6xxx series of aluminum alloy. Afterwards, the assembled sheets have been brazed flat with 0 or 2 or 5 g/m² of a Nocolok® type flux on the brazing layer 17. The brazing cycle has been carried out with holding for about 2 minutes at about 600° C. under a controlled atmosphere (O₂<50 ppm).

Afterwards, the length of each brazing joint has been measured. For each configuration, three samples have been made. For each sample, two measurements have been made at the level of the two stamped longitudinal lines. The results may be expressed in terms of brazed length in mm, or in terms of percentage of brazed length with respect to the maximum possible length.

“A” corresponds to more than 90%; “B” corresponds to an interval from 50 to 90%; “C” corresponds to an interval from 10 to less than 50%; “D” corresponds to less than 10%.

The results of the brazing test are disclosed in Table 3 hereinafter.

TABLE 3

| | fluxless | 2 g/m² | 5 g/m² |
|---|---|---|---|
| Config-1 | D | B | A |
| Config-2 | D | B | A |

Good brazability has been obtained with a 5 g/m² flux for all configurations.

### Example 2: Mechanical Properties of a Three-Layer Sandwich

On the samples of Example 1 hereinbefore (according to the configurations Config-1 and Config-2), after cold-rolling to a thickness of 1.5 mm, different annealings have been carried out: a strip line type annealing (30 seconds at about 400° C. or 45 seconds at about 550° C.) or a batch-type annealing (2 hours at about 360° C.).

A CAB-type (controlled atmosphere) brazing for about 2 minutes at about 600° C. with cooling at a rate higher than 40° C./min below 380° C. and to 100° C. has been carried out. Afterwards, a tempering for 2 hours at about 195° C. has been carried out.

The tensile mechanical properties have been measured in the rolling direction after annealing, and after annealing+brazing+tempering according to the standard ISO 6892-1.

TABLE 4

| | | | | | After annealing + brazing + | | |
|---|---|---|---|---|---|---|---|
| | | After annealing | | | tempering 2 h 195° C. | | |
| | | Rp_{0.2} | Rm | Elongation | Rp_{0.2} | Rm | Elongation |
| Configuration | Annealing | MPa | MPa | % | MPa | MPa | % |
| Config-1 | 400° C. 30 s | 54 | 130 | 25.0 | 194 | 232 | 9.3 |
| | 550° C. 45 s | 107 | 207 | 25.0 | 195 | 231 | 8.0 |
| | 2 h 360° C. | | | | 198 | 234 | 9.3 |
| Config-2 | 400° C. 30 s | 53 | 131 | 27.3 | 171 | 211 | 12.0 |
| | 550° C. 45 s | 86 | 181 | 25.9 | 172 | 211 | 11.8 |
| | 2 h 360° C. | | | | 169 | 209 | 10.7 |

It seems that the duration and the temperature of the annealing have no influence on the value of Rp_{0.2} after annealing+brazing+tempering. In all cases, the value of Rp_{0.2} of the set is higher than 165 MPa. It is higher for the set with a core made of a 6xxx-1 alloy (Config-1) which contains more magnesium than the set with a core made of a 6xxx-2 alloy (Config-2).

### Example 3: Corrosion

Measurements of corrosion resistance according to the SWAAT test have been carried out on the configurations Config-1 and Config-2 described in Examples 1 and 2 hereinbefore, on samples having a thickness of about 1 mm, on the face plated with the sacrificial layer and after annealing for 2 hours at about 360° C. and then brazing for 2 minutes at about 600° C. and then tempering for 2 hours at about 195° C.

The corrosion resistance has been determined according to the following protocol:
preparing for each configuration a sample with the dimensions 126 mm (L direction)×90 mm (TL direction), degreased beforehand with a white absorbent paper soaked with acetone;
protecting the untested face (face plated with the brazing layer) as well as the four edges over a width of about 0.5 cm with a transparent vinyl adhesive (for example of the 3M vinyl 764 type);
cleaning the face to be tested (face plated with the sacrificial layer) with an absorbent paper soaked with acetone;
placing the samples thus prepared on a rack with an inclination of about 60° with respect to the horizontal;
carrying out, for each sample, a SWAAT (Sea Water Acidified Acetic test) cyclic test according to the standard ASTM G85 A3, comprising in particular an alternation of 30 min salt spray phases and of 1h30 wet phases at a temperature of about 49° C.

The number of perforations has been monitored every day for each sample throughout the duration of the test, namely 20 days. The perforations could be visible on the back of each sample because they form blisters in the adhesive applied over the face that is not tested, as illustrated in FIG. 4. In FIG. 4, the reference 6 corresponds to the sample; the reference 7 corresponds to the adhesive; the reference 8 corresponds to a perforation; the reference 9 corresponds to a blister formed by a perforation.

The obtained results were that there have been no perforations after 20 days of testing, for none of the configurations Config-1 and Config-2.

Afterwards, the samples have been observed in polished section using a microscope: the depth of the pits (non-through) was smaller than 60 μm for the two configurations Config-1 and Config-2.

### Example 4: Mechanical Properties

Tests for simulating a brazing cycle (heating at about 600° C., holding for 2 minutes, and then cooling at a rate higher than 50° C./min from 380° C. and down to 100° C.) and a post-brazing tempering (several temperatures and holding durations have been tested-cf. Table 6 hereinafter) have been carried out on different compositions of an aluminum alloy cores of the 6xxx series (cf. Table 5 hereinafter) without plating. The sheets made of the 6xxx series of aluminum alloy have been obtained by homogenization at a temperature higher than 500° C. for a time period longer than 3 hours, and then hot-rolling at a temperature of 350 to 450° C. to a thickness of about 2.8 mm, and then cold-rolling to a thickness of about 0.8 mm, and then annealing at a temperature of 440 to 500° C. for a time period of 30 to 45 seconds.

TABLE 5

| | | | | | | Solidus T |
|---|---|---|---|---|---|---|
| | Si | Fe | Cu | Mn | Mg | (° C.) |
| 6xxx-3 | 0.56 | 0.23 | 0.08 | 0.17 | 0.26 | 621 |
| 6xxx-4 | 0.60 | 0.23 | 0.08 | 0.17 | 0.34 | 618 |

The tensile mechanical properties have been measured in the rolling direction after annealing+brazing+tempering according to the standard ISO 6892-1. The obtained results are disclosed in Table 6 hereinafter.

TABLE 6

| | Tempering | Prop. | Tempering duration (h) | | | | | | | | | |
|---|---|---|---|---|---|---|---|---|---|---|---|---|
| Alloy | T° | Mech. | 0 | 1 | 2 | 2.5 | 3 | 4 | 5 | 6 | 8 | 9 |
| 6xxx-3 | 205° C. | Rp_{0.2} | 55 | 84 | 107 | | 123 | | 129 | | 141 | |
| | | Rm | 146 | 147 | 156 | | 164 | | 168 | | 178 | |
| | | A % | 22.0 | 19.6 | 13.8 | | 11.5 | | 8.8 | | 10.6 | |
| 6xxx-4 | 175° C. | Rp_{0.2} | | | | | 180 | | | 215 | | 225 |
| | | Rm | | | | | 235 | | | 254 | | 258 |
| | | A % | | | | | 15.1 | | | 13.8 | | 12.5 |
| | 185° C. | Rp_{0.2} | | | | 199 | | 214 | | 218 | | |
| | | Rm | | | | 239 | | 246 | | 249 | | |
| | | A % | | | | 12.9 | | 11.7 | | 11.5 | | |
| | 195° C. | Rp_{0.2} | | | 198 | | | 209 | | | | |
| | | Rm | | | 233 | | | 239 | | | | |
| | | A % | | | 11.9 | | | 12.0 | | | | |
| | 205° C. | Rp_{0.2} | 73 | 168 | 184 | | 184 | | 182 | | | |
| | | Rm | 173 | 209 | 216 | | 215 | | 214 | | | |
| | | A % | 23.0 | 11.0 | 10.4 | | 9.9 | | 11.1 | | | |

The 6xxx-4 alloy demonstrated improved post-brazing mechanical characteristics compared to those of the 6xxx-3 alloy, to the detriment of a drop in the solidus temperature at 618° C. (cf. Table 6 hereinbefore).

### Example 5: Mechanical Properties

Castings of different compositions of aluminum alloys of the 6xxx series have been carried out. Table 7 hereinafter shows the contents of elements of the different alloys, in weight 10 percentages.

TABLE 7

| | | | | | | | | Solidus |
|---|---|---|---|---|---|---|---|---|
| Alloy | Si | Fe | Cu | Mn | Mg | V | Ti | (° C.) |
| A | 0.60 | 0.22 | 0.08 | 0.17 | 0.37 | 0.011 | 0.033 | 618.0 |
| B | 0.61 | 0.23 | 0.30 | 0.07 | 0.36 | 0.012 | 0.033 | 611.8 |
| B′ | 0.61 | 0.23 | 0.30 | 0.07 | 0.36 | 0.012 | 0.033 | 611.8 |
| C | 0.70 | 0.23 | 0.38 | 0.07 | 0.36 | 0.012 | 0.034 | 605.8 |
| D | 0.60 | 0.23 | 0.29 | 0.07 | 0.37 | 0.14 | 0.036 | 618.5 |
| H | 0.60 | 0.22 | 0.08 | 0.07 | 0.49 | 0.14 | 0.034 | 619.1 |
| E | 0.61 | 0.24 | 0.29 | 0.08 | 0.49 | 0.011 | 0.032 | 608.3 |
| F | 0.59 | 0.23 | 0.45 | 0.07 | 0.50 | 0.011 | 0.035 | 606.3 |
| G | 0.46 | 0.14 | 0.39 | 0.07 | 0.42 | 0.012 | 0.031 | 615.2 |

The sheets of aluminum alloy of the 6xxx series have been obtained by homogenization at a temperature of about 540° C. for a time period of about 6 hours (except for the alloy B′ which has not undergone homogenization), and then hot-rolling at a temperature of about 490° C. to a thickness of about 4.5 mm, and then cold-rolling to a thickness of about 2.0 mm, and then annealing at a temperature of about 360° C. for a time period of about 2 hours.

Tests for simulating a brazing cycle (heating at about 600° C., holding for 2 minutes, and then cooling at a rate higher than 50° C./min from 380° C. and up to 100° C.) and a post-brazing tempering (1 hour at 195° C., 4 hours at 195° C., 2 hours at 205° C. or 2 hours at 210° C.—cf. Table 8 hereinafter) have been carried out on the alloys A to G of Table 7 hereinbefore. The oxygen content during the brazing simulation was less than 50 ppm.

The tensile mechanical properties have been measured in the rolling direction after annealing+brazing+tempering according to the standard ISO 6892-1. The obtained results are disclosed in Table 8 hereinafter, wherein the values of Rp_{0.2} and Rm are expressed in MPa.

TABLE 8

| | Tempering | | | | | | | | | | | |
|---|---|---|---|---|---|---|---|---|---|---|---|---|
| | 1 h 195° C. | | | 4 h 195° C. | | | 2 h 205° C. | | | 2 h 210° C. | | |
| Alloy | Rp_{0.2} | Rm | A % | Rp_{0.2} | Rm | A % | Rp_{0.2} | Rm | A % | Rp_{0.2} | Rm | A % |
| A | 180 | 231 | 14.67 | 189 | 220 | 11.94 | 158 | 197 | 10.2 | 176 | 215 | 13.1 |
| B | 183 | 237 | 14.82 | 210 | 251 | 12.22 | 205 | 241 | 11.1 | 205 | 243 | 11.4 |
| B′ | 180 | 232 | 13.2 | 207 | 244 | 13.1 | 200 | 236 | 11.9 | | | |
| C | 186 | 246 | 16.07 | 216 | 259 | 12.93 | 216 | 257 | 10.4 | | | |
| D | 174 | 222 | 12.27 | 217 | 250 | 13.42 | 194 | 231 | 11.3 | 201 | 238 | 12.1 |
| H | 153 | 214 | 15.40 | 220 | 253 | 11.47 | 199 | 232 | 11.3 | | | |
| E | 190 | 249 | 15.65 | 222 | 263 | 11.97 | 234 | 266 | 11.6 | | | |
| F | 209 | 267 | 10.90 | 236 | 277 | 12.24 | | | | | | |
| G | 187 | 238 | 14.18 | 216 | 256 | 12.97 | | | | 213 | 521 | |

On the other hand, a corrosion resistance test (not illustrated herein) has been carried out on the core alloys A, B, F and G sandwiched between a brazing layer-1 of Table 2 hereinbefore (7.5% of the total thickness of the sandwich) and the sacrificial layer of Table 2 hereinbefore (10% of the total thickness of the sandwich). A SWAAT test according to the standard ASTM G85 A3 (as described hereinbefore in Example 3) has been carried out. The results have been obtained by polished section microscopic analysis after 40 days of testing. The total thickness of the sandwiches has been about 0.8 mm. It has been noticed that the corrosion resistance of the sandwich comprising the core alloy F has been less good than that of the sandwiches comprising the core alloys A, B and G, since a greater pitting depth has been observed for the core alloy F. Moreover, it should be noted that the core alloy G comprises an Fe content which is not very suitable for recycling.

### Example 6: Mechanical Properties

Tests for simulating a brazing cycle (heating at about 600° C., holding for 2 minutes, and then cooling at a rate higher than 50° C./min from 380° C. and up to 100° C.) and a post-brazing tempering (several temperatures and holding durations have been tested-cf. Table 10 hereinafter) have been carried out on a sheet comprising a core made of the 6xxx series of aluminum alloy (6xxx-5 alloy) plated on two faces with a sacrificial layer made of the 7xxx series of aluminum alloy (7xxx-1 alloy), each of the two sacrificial layers representing 10% of the total thickness of the sheet. The compositions of the aluminum alloys are given in Table 9 hereinafter, in weight percentages.

TABLE 9

| | Si | Fe | Cu | Mn | Mg | Zn | Ti |
|---|---|---|---|---|---|---|---|
| 6xxx-5 | 0.62 | 0.24 | 0.09 | 0.16 | 0.36 | 0.02 | 0.03 |
| 7xxx-1 | 0.13 | 0.3 | — | — | — | 1.01 | 0.03 |

The core layer made of the 6xxx series of aluminum alloy has been homogenized at a temperature comprised from 540 to 600° C. for a time period longer than 3 hours, and then assembled with the two sacrificial layers made of the 7xxx series of aluminum alloy, which have been hot-rolled beforehand. The sandwich thus obtained has been preheated, and then hot-rolled to a thickness of about 4 mm, and then cold-rolled to a thickness of about 2 mm, and then annealed at a temperature of about 350° C. for a time period of about 30 minutes.

The tensile mechanical properties have been measured in the rolling direction after annealing+brazing+tempering according to the standard ISO 6892-1. The obtained results are disclosed in Table 10 hereinafter.

TABLE 10

| | | | | |
|---|---|---|---|---|
| Tempering | Tempering | | | |
| time | T° (° C.) | Rp_{0.2} (MPa) | Rm (MPa) | A % |

| | | | | | |
|---|---|---|---|---|---|
| 4 | hours | 195 | 171 | 208 | 12.0 |
| 1 | hour | 210 | 152 | 191 | 12.6 |
| 45 | min | 225 | 143 | 180 | 14.2 |

1. A strip or sheet, intended for the manufacture of brazed heat exchangers, optionally battery coolers of electric vehicles, comprising, optionally consisting of, a core layer, optionally a cover layer on one or two face(s) of the core layer and optionally an interlayer on one or two face(s) of the core layer placed between the core layer and the cover layer, the core layer being made of the 6xxx series of aluminum alloy having the following composition, in weight percentages:
Si: from 0.45 to 0.75; optionally from 0.50 to 0.70%; optionally from 0.55 to 0.65%;
Fe: from 0.18 to 0.40%; optionally from 0.18 to 0.35%; optionally from 0.18 to 0.30%; optionally from more than 0.18 to 0.26%;
Cu: ≤0.40%; optionally ≤0.25%; optionally ≤0.15%; and optionally >0.05% according to a first variant; or optionally from 0.25 to 0.40%; optionally from 0.29 to 0.40% according to a second variant;
Mn: ≤0.30%; optionally ≤0.20%; optionally ≤0.15%; optionally≤0.10%;
Mg: from 0.25 to 0.56%; optionally from 0.25 to 0.45%; optionally from 0.30 to 0.39%;
Ti: <0.050%; optionally <0.045%; optionally <0.040%;
optionally V: from 0.05 to 0.16%;
unavoidable impurities: <0.05% each and <0.15% in total;
the remainder being aluminum.

2. The strip or sheet according to claim 1, comprising said core layer made of the 6xxx-series of aluminum alloy, a cover layer on one or both face(s) of the core layer and preferably an interlayer on one or two face(s) of the core layer placed between the core layer and the cover layer.

3. The strip or sheet according to claim 2, comprising a cover layer on one face of the core layer, and wherein:
the cover layer is a brazing layer; or
the cover layer is a sacrificial layer.

4. The strip or sheet according to claim 2, comprising a cover layer on both faces of the core layer, and wherein:
one of the cover layers is a sacrificial layer and the other cover layer is a brazing layer; or
the two cover layers are sacrificial layers; or
the two cover layers are brazing layers.

5. The strip or sheet according to claim 2, comprising a cover layer which is a sacrificial layer on at least one face of the core layer, the aluminum alloy of the sacrificial layer optionally comprising less than 2.50%, and optionally at least 0.50% by weight of Zn.

6. The strip or sheet according to claim 3, wherein the aluminum alloy of the sacrificial layer is selected from an alloy of the 1xxx, 7xxx or 3xxx series.

7. The strip or sheet according to claim 6, wherein the aluminum alloy of the sacrificial layer is a 7xxx series alloy, optionally having the following composition, in weight percentages:
less than 0.50% Si;
less than 0.50% Fe;
less than 0.25% Cu;
less than 0.30% Mn;
less than 0.20%, optionally less than 0.15% Mg;
from 0.50 to less than 2.50%, optionally from 0.70 to less than 2.50%, optionally from more than 0.80 to less than 1.30% Zn;
less than 0.15% Ti;
other elements less than 0.05% each and less than 0.15% in total;
the remainder being aluminum.

8. The strip or sheet according to claim 6, wherein the aluminum alloy of the sacrificial layer is an alloy of the 3xxx series, optionally having the following composition, in weight percentages:
0.10 to 0.35% Si;
less than 0.70% Fe;
less than 0.20% Cu;
from 0.70 to 2.00%, optionally from 0.90 to 1.30% Mn;
from 0.80 to less than 1.30% Zn;
less than 0.15% Ti;
other elements less than 0.05% each and less than 0.15% in total;
the remainder being aluminum.

9. The strip or sheet according to claim 3, wherein the aluminum alloy of the brazing layer is an alloy of the 4xxx series, optionally comprising from 4.00 to 13.00% by weight Si and less than 1.00% by weight Fe, and optionally having the following composition, in weight percentages:
Si: from 5.00 to 13.00%, optionally from 6.00 to 11.00%;
Fe: less than 0.60%, optionally less than 0.50%, optionally less than 0.30%;
Cu: less than 0.40%, optionally less than 0.10%, optionally less than 0.05%;
Mn: less than 0.20%, optionally less than 0.10%, optionally less than 0.05%;
Mg: according to a first variant less than 0.20%, optionally less than 0.10%, optionally less than 0.05%; or according to a second variant from 0.50 to 2.50%, optionally from 1.00 to 2.00%;
Zn: less than 0.20%, optionally less than 0.10%, optionally less than 0.05%, optionally less than 0.02%;
Ti: less than 0.30%, optionally less than 0.10%, optionally less than 0.05%;
optionally Bi, Y, Sr and/or Sn;
other elements: less than 0.05% each and less than 0.15% in total;
the remainder being aluminum.

10. A set of two sheets or strips comprising, optionally consisting of:
a flat part formed from a strip or sheet claim 2;
a stamped part formed from the strip or sheet;
the two parts being intended to be assembled by brazing and forming a channel due to deformation of the stamped part, the outermost layer of the stamped part and/or of the flat part in contact with the other part being a brazing layer.

11. A method for manufacturing a strip or sheet according to claim 1, comprising successively:
casting a core alloy plate;
optionally homogenizing the plate at a temperature of 450 to 580° C., optionally from 520 to 560° C. for 1 to 24 hours;
optionally plating with a cover aluminum alloy (16, 17) on one or two face(s) of the core layer and optionally an interlayer aluminum alloy on one or two face(s) of the core layer;
preheating at a temperature of 400 to 550° C., optionally from 450 to 530° C., optionally from 480 to 510° C., optionally with holding at the maximum temperature for less than 30 hours, optionally for less than 20 hours, optionally for less than 12 hours, more optionally for less than 3 hours;
hot-rolling the optionally homogenized and optionally plated plate at a temperature of 390 to 530° C., optionally from 470 to 530° C., to a thickness of 2 to 6 mm,
cold-rolling to the desired thickness, the thickness of the strip or sheet after cold-rolling being optionally from 0.15 to 3 mm and
heat treating in a passage furnace at a temperature of 250 to 560° C., optionally from 320 to 430° C., optionally from 320 to 360° C. with holding at a maximum temperature for less than 5 minutes, optionally less than 1 minute, optionally for less than 30 seconds and optionally more than 15 seconds, or in a batch furnace at a temperature of 250 to 390° C., optionally from 310 to 360° C., with holding at the maximum temperature optionally for less than 3 hours, optionally for less than 2 hours and optionally less than 1 hour, so as to obtain a small-grain recrystallization.

12. A heat exchanger made at least in part from a strip or sheet according to claim 2, or from a set of two sheets or strips.

13. A product comprising a strip or sheet according to claim 1, or of a set of two sheets or strips, for manufacturing a heat exchanger, optionally a battery cooler for an electric vehicle.

14. A product according to claim 13, comprising having been made by at least one of:
brazing in a CAB (controlled atmosphere) furnace, optionally at a temperature of 590 at 615° C., optionally from 590 to 610° C., optionally from 590 to 605° C., optionally from 590 to 600° C.;
Cooling optionally having a speed higher than 25° C./min, optionally higher than 35° C./min, optionally higher than 50° C./min below 380° C. and up to 100° C. at the end of the brazing cycle;
Post-brazing tempering optionally at a temperature of 150 to 240° C., optionally from 180 to 220° C., for a time period optionally of less than 6 hours, optionally less than 3 hours.
